(19) United States
(12) Patent Application Publication
(10) Pub. No.: US 2012/0252918 A1
(43) Pub. Date: Oct. 4, 2012

(54) Method and composition for insulative composite building material

(76) Inventor: Earl M. Stenger, San Antonio, TX (US)

(21) Appl. No.: 13/065,771

(22) Filed: Mar. 30, 2011

(51) Int. Cl. C08L 23/12

(52) U.S. Cl. 521/143

(57) ABSTRACT

An insulative and relatively low-weight aggregate building material comprising an expanded plastic polymer and a method of producing the material are provided. The building material resists freeze-thaw damage and is sufficiently strong to be used in most building applications.

### FIELD OF THE INVENTION

The present invention relates generally to a composition and method for creating an insulative composite building material and, more particularly, to a composite building material comprising expanded plastic polymer aggregate.

### BACKGROUND OF THE INVENTION

Increasing the insulative capacity of building materials, such as concrete, has numerous benefits. One primary benefit is the prevention or minimization of damage to building materials caused by thermal stress and freeze-thaw actions. Concrete contains water, which is subject to freezing in cold temperatures. When water within concrete freezes, it expands in volume by about 9%, stressing the concrete. Successive freeze-thaw cycles can eventually result in cracking, scaling, and crumbling of concrete structures. Damage to buildings and other structures from freeze-thaw actions is almost always costly, and can be devastating if an occupied building or concrete bridge collapses.

Another important benefit of increasing the insulative capacity of building materials is improvement in the energy efficiency of the structures the materials are used to construct. For example, improving the insulative capacity of concrete walls or blocks used in the construction of a building can stabilize temperatures within the building and lower heating and air conditioning costs.

One class of materials that is recognized as an excellent insulator is foam plastics, or expanded plastic polymers. The insulative capacity of these materials primarily derives from the high air content of expanded plastic polymers. The foaming or expansion process used in manufacturing expanded plastic polymer particles introduces a significant amount of air into the material, and air is known as an excellent insulator. In fact, expanded plastic polymer particles may be comprised of up to 95% air or more, depending on the particular materials and methods used. Because of the excellent insulative properties resulting from the high air content, expanded plastic polymers have been used in materials such as coffee cups, coolers, packing materials, wall insulation, and other similar materials.

Incorporating expanded plastic polymer into aggregate building materials sufficiently strong to be used in most building applications, such as, for example, blocks, bricks, slabs, walls, piers, piles, bridges, and other structures and building units, would be very beneficial. First, the insulative properties of expanded plastic polymer would prevent or minimize damage caused by freeze-thaw actions and increase the energy efficiency of the resulting structures. In addition, incorporating expanded plastic polymer into composite materials in place of traditional aggregate may lower labor and material costs. Foam plastic typically costs less than traditional aggregate and, because the material weighs less, allows for lower transportation and labor costs.

Previous efforts to incorporate plastic into building materials have failed to fully achieve the foregoing goals for various reasons. For example, U.S. Pat. No. 5,422,051 to Sawyers describes recycling solid plastic scrap waste by using it as the aggregate for cementitious building material. The objective of Sawyers is to recycle solid plastic waste and produce a lightweight cement, not to create an insulative building material. The material in Sawyers does not provide any insulative benefit because the aggregate material consists of non-expanded solid plastic, not expanded foam plastic. Solid, non-expanded plastic lacks the insulating qualities of expanded plastic.

Similarly, recycling waste foamed plastic by crushing the material and incorporating it into composite materials has been discussed in the prior art. However, crushed foamed plastic waste lacks the insulative qualities of uncrushed expanded plastic polymer particles. When the waste foam plastic is crushed, the closed cells of the foam are ruptured and the foam particles collapse. The resulting material has far less air, and thus less insulative capacity, than uncrushed expanded plastic polymer particles.

Other efforts to develop insulative building materials incorporating plastic have failed to produce building materials that are sufficiently strong to be used in many building applications. For example, U.S. application Ser. No. 10/075,405 to Boronkay describes a light-weight concrete containing foamed plastic balls or particles, but no crushed rock or other coarse or intermediate aggregate material. Without traditional rock or stone aggregate, such as granite or limestone, the light-weight concrete described in Boronkay may be used only in certain limited applications. The material described in Boronkay would lack sufficient strength to be used in place of traditional aggregate building materials in many cases where structural strength is important.

What is needed, therefore, is an insulative and relatively low-weight aggregate building material comprising an expanded plastic polymer that is sufficiently strong to be used in most building applications, such as, for example, blocks, bricks, slabs, walls, piers, piles, bridges, and other structures and building units. Moreover, in order to be adopted by the industry, the method for producing such a material should not be overly burdensome and should be easily employed and understood by individuals that are familiar with mixing traditional concrete and other aggregate building materials.

### BRIEF SUMMARY OF THE INVENTION

The present invention solves the foregoing problem by providing an aggregate building material wherein a percentage of coarse aggregate is replaced with expanded plastic polymer by volume and further providing a method for producing said aggregate building material.

One embodiment of the present invention consists of a composite building material comprising a binder, such as Portland cement or asphalt, and aggregate, including both a coarse mineral aggregate and an expanded plastic polymer aggregate. In certain embodiments, the expanded plastic polymer aggregate comprises roughly 2% to 30% of the total aggregate by volume. By combining both standard mineral aggregate and non-crushed insulative expanded plastic polymer particles, a building material that is relatively light-weight and resistant to freeze-thaw damage, but still strong enough to be used in most building applications is produced.

One method for producing this exemplary embodiment comprises employing one of the many mixture proportions known in the art for a standard composite building material, but replacing between 2% and 30% of the volume of coarse aggregate or coarse and intermediate aggregate with an equal volume of expanded plastic polymer particles. Such a method would be easily employed and understood by individuals that are familiar with mixing traditional concrete and other aggregate building materials, and could therefore be easily adopted by the industry.

### BRIEF DESCRIPTION OF THE DRAWINGS

The foregoing summary, as well as the following detailed description of the invention, will be better understood when read in conjunction with the appended drawings. For the purpose of illustrating the invention, the drawings depict embodiments of the invention that are presently preferred. It should be understood, however, that the invention is not limited to the precise arrangements and methods shown.

In the drawings:

FIG. 1 shows a cross-sectional view of a building material produced according to one embodiment of the present invention.

FIG. 2 shows a cross-sectional view of a building material produced according to a second embodiment of the present invention.

FIG. 3 illustrates a method for producing a building material according to one embodiment of the present invention.

### DETAILED DESCRIPTION OF THE PREFERRED EMBODIMENTS

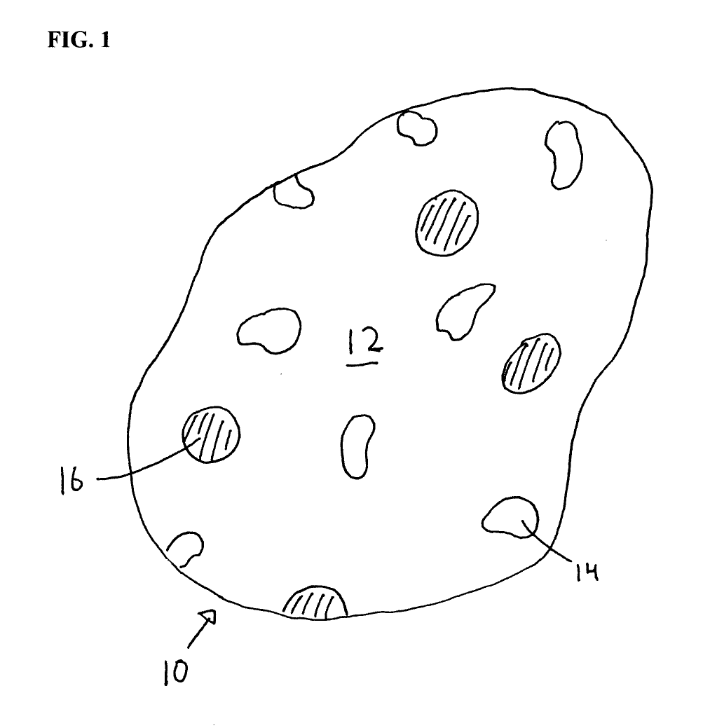

FIG. 1 shows a composite building material 10 in accordance with one embodiment of the present invention. The composite building material 10 is comprised of a binder 12, such as Portland cement or asphalt, and aggregate, including both a mineral aggregate 14 and expanded plastic polymer aggregate 16. The water content (where applicable) and the ratio of binder 12 to total aggregate content in the composite building material 10 may vary depending on the intended use of the material. An individual with ordinary skill in the art will be able to determine the materials and mixture proportions best suited for obtaining a homogenous composite building material suitable for the intended purpose. In certain embodiments of a cement concrete composite building material, the total amount of aggregate comprises approximately 80% of the final mixture by volume.

The mineral aggregate 14 may consist of any of the variety of coarse or intermediate aggregates known in the art. For example, in certain embodiments, the mineral aggregate 14 comprises gravel or crushed rock, such as limestone or granite. In certain embodiments, the maximum size of mineral aggregate particles 14 is roughly one inch in diameter.

The expanded plastic polymer aggregate 16 may comprise any expanded plastic polymer material, or foamed plastic. Exemplary materials include expanded polystyrene and expanded polypropylene. The expanded plastic polymer aggregate 16 may be comprised of particles in a variety of shapes and sizes. In certain embodiments, the expanded plastic polymer aggregate 16 comprises spherical foam pellets or particles with diameters in the approximate range of ¼″ to 1″ in diameter. In other embodiments, the expanded plastic polymer aggregate 16 comprises particles of other shapes and sizes, including cylindrical and non-uniform shaped particles. The amount of expanded plastic polymer aggregate 16 may vary depending on the particular application. In certain embodiments, the expanded plastic polymer aggregate 16 comprises roughly 2% to 30% by volume of the total aggregate. Generally, a composite building material 10 having a higher ratio of expanded plastic polymer aggregate 16 to mineral aggregate 14 by volume will be lighter and more insulative than a material with a lower ratio of expanded plastic polymer aggregate 16 to mineral aggregate 14, but such a material will generally have less compressive strength.

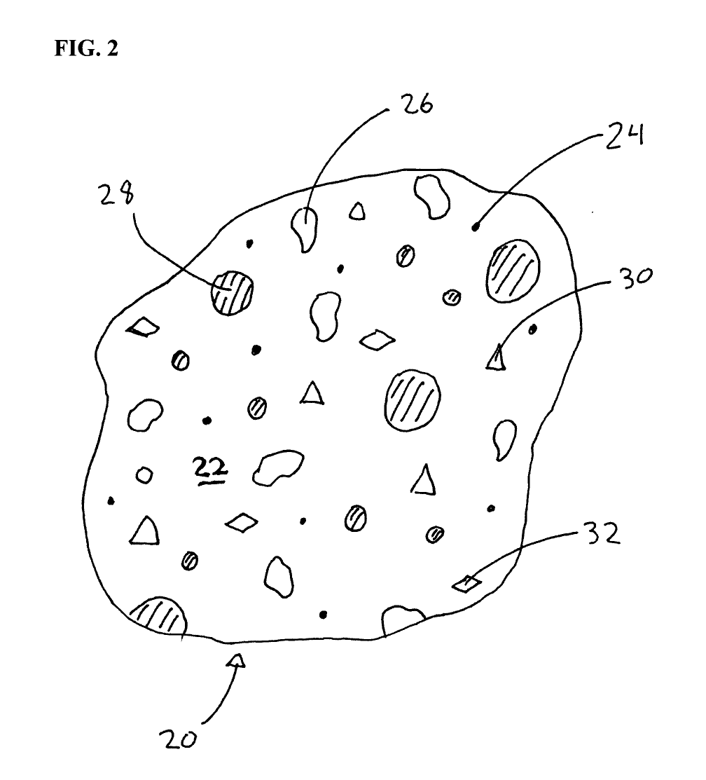

FIG. 2 shows a cement concrete building material 20 in accordance with a second embodiment of the present invention. The exemplary cement concrete building material 20 is comprised of a cement binder 22, preferably comprising Portland cement. The cement concrete building material 20 is further comprised of fine aggregate material 24, such as sand, and intermediate and coarse aggregate materials 26, such as gravel or crushed limestone, granite, or other rock. The intermediate and coarse aggregated materials 26 are preferably one inch in diameter or less, although other sizes may be used depending on the application.

The cement concrete building material 20 shown in FIG. 2 is further comprised of an expanded polypropylene particle aggregate 28. Multiple sizes of expanded polypropylene particles 28 may be used. In certain embodiments, spherical polypropylene pellets having approximate diameters of ¼″ and 1″ are used in the mixture in a ratio of 2 parts ¼″ pellets to 1 part 1″ pellets. In the present example, the expanded polypropylene particles 28 may comprise roughly 2% to 30% of the total aggregate, excluding the fine aggregate 24, by volume. In certain embodiments, the expanded polypropylene particles 28 may comprise 5% to 15% of the total volume of expanded polypropylene particles 28 combined with intermediate and coarse aggregate materials 26.

The cement concrete building material 20 shown in FIG. 2 may also include any of the variety of chemical admixtures known in the art. Such chemical admixtures may include, for example, air entraining agents 30 for increasing the air content of the material and superplasticizer admixtures 32 for increasing the workability of the mixture. Although the admixtures illustrated in FIG. 2 are shown in granular form, chemical admixtures may be liquid in form as known to those skilled in the art.

The cement concrete building material 20 of FIG. 2 is prepared according to methods presently understood in the art and may be modified as needed depending on the particular application. For example, in preparing the cement concrete building material 20, water is added to initiate hydration of the concrete mixture in an amount appropriate for the particular application as is understood in the art. In certain embodiments of the present invention, a water-cement ratio of 0.4 may be used.

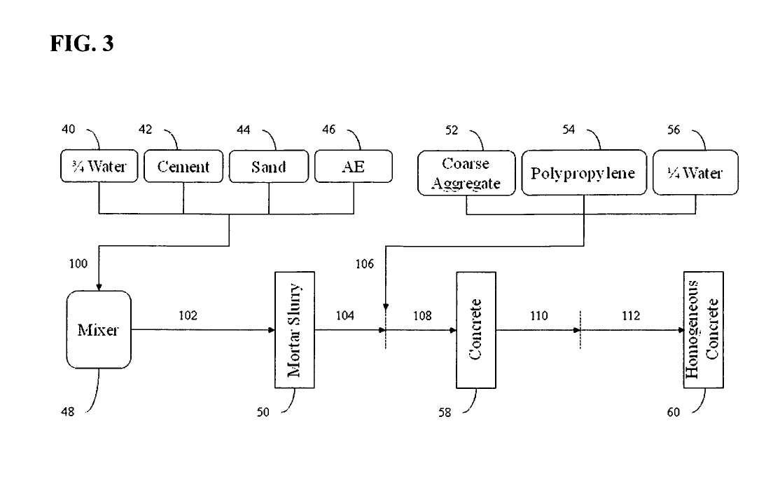

FIG. 3 shows a diagram illustrating one method for producing one embodiment of the building material shown in FIG. 2. In the method shown in FIG. 3, a homogeneous cement concrete mixture 60 is produced in two stages. In the first stage, a mortar slurry 50 is produced. In step 100, ¾ of the total amount of water to be used is placed in a paddle mixer 48 and the desired quantities of cement 42, fine aggregate 44, and chemical admixtures 46 are added. In step 102, the mixture is mixed at medium speed for thirty seconds until a mortar slurry 50 is produced. The mortar slurry 50 is then mixed for an additional thirty seconds as shown in step 104. In the second stage of the method, the desired amount of intermediate and coarse aggregate 52 and expanded polypropylene particles 54 are added to the mixer 48 along with the remaining ¼ of the total water to be added 56, as shown in step 106. In step 108, the mixture is mixed at medium speed for sixty seconds until the materials in the mixture are uniformly distributed and a concrete mixture 58 is produced. The mixture is allowed to rest for sixty seconds in step 110 and then, as shown in step 112, is mixed for an additional sixty seconds at medium speed until a homogeneous cement concrete mixture 60 with no lumps is produced. In alternative embodiments, the order of the steps and the mixing times may be modified as desired. In certain embodiments, a cement concrete mixture is produced in a single stage, without first preparing a mortar slurry.

Composite building materials produced according to the present invention have a relatively high resistance to freeze-thaw damage, yet still maintain sufficient compressive strength to be used in a wide range of structural building components, including bricks, blocks, slabs, walls, piers, piles, bridges, and other structures and building units. The ratio of expanded plastic polymer aggregate to the total aggregate used by volume has an impact on the strength of the building material as well as its insulative capacity and weight. Generally, materials where a high percentage of the total aggregate is comprised of expanded plastic polymer will be better insulators and will generate the greatest labor and transportation cost savings. Reducing the percentage of expanded plastic polymer aggregate by volume and thereby increasing the amount of coarse aggregate will generally result in a stronger building material, while still maintaining some insulative and cost benefits. Based on these principles, a person of ordinary skill in the art would have no difficulty adapting the present invention to a variety of particular building applications.

Additional advantages to the present invention have been observed. In particular, cement concrete incorporating expanded polypropylene particles prepared according to the present invention has a low density, a high permeable void and absorption percent, a coarse texture, a high friction (skid resistance), low heat development, and low thermal conductivity compared to normal concrete.

The following examples further describe and demonstrate embodiments within the scope of the present invention. The examples are given solely for the purpose of illustration and are not to be construed as limiting the present invention, as many variations are possible without departing from the spirit and scope of the invention.

### Example 1

Three formulations of cement concrete with 2% air content were prepared in a laboratory setting according to the method illustrated in FIG. 3 and using the mixture proportions shown in Table 1. The water-cement ratio for all formulations was 0.40. The expanded plastic polymer aggregate used consisted of one part 1″ diameter expanded polypropylene pellets and two parts ¼″ diameter polypropylene pellets. The coarse and intermediate aggregate consisted of limestone aggregate not exceeding 1″. The fine aggregate consisted of river sand. Type 1 Portland cement was used for all formulations.

TABLE 1
Mixture Proportions (2% Air)

| | | | | | | | | Air |
|---|---|---|---|---|---|---|---|---|
| | | | | | | Expanded | Super- | Entraining |
| | | | | | | Plastic | plasticizer | Agent |
| | Water | Cement | Fine | Coarse | Inter. | Polymer | (% mass of | (% mass of |
| Formulation | (lb) | (lb) | Agg. (lb) | Agg. (lb) | Agg. (lb) | Agg. (lb) | cement) | cement) |
| A. Plain w/ 2% air | 188 | 470 | 1348.9 | 1162.1 | 888.4 | 0 | 0.7 | 0 |
| B. 5% Polypropylene | 188 | 470 | 1348.9 | 1133.0 | 866.2 | 51.3 | 0.7 | 0 |
| w/ 2% air | | | | | | | | |
| C. 15% Polypropylene | 188 | 470 | 1348.9 | 1074.9 | 821.2 | 153.8 | 0.7 | 0 |
| w/2% air | | | | | | | | |

The freeze-thaw resistance of each formulation of cement concrete identified in Table 1 was determined by calculating the durability factor for each formulation. Three samples of each formulation were subjected to 300 freeze-thaw cycles in the laboratory, the relative dynamic modulus of elasticity for each sample was determined, and the durability factor for each sample was calculated. The durability factor for each sample of each formulation after the full 300 freeze-thaw cycles is shown in Table 2.

TABLE 2
Durability Factor (DF) (2% Air)

| | | Sample 1 | Sample 2 | Sample 3 | Average |
|---|---|---|---|---|---|
| Formulation | | DF | DF | DF | DF |
| A. | Plain w/ 2% air | 56.36321 | 54.82114 | 54.84003 | 55.34 |
| B. | 5% Polypropylene | 69.71231 | 67.03516 | 62.59013 | 66.45 |
| | w/ 2% air | | | | |
| C. | 15% Polypropylene | 76.27111 | 69.53188 | 71.25991 | 72.35 |
| | w/2% air | | | | |

The strength of each formulation of cement concrete identified in Table 1 was determined by calculating the compressive strength of three samples of each formulation as tested after 7, 14, and 28 days. The average compressive strength of each formulation after 7, 14, and 28 days is shown in Table 3.

TABLE 3
Average Compressive Strength (2% Air)

| Formulation | | Day 7 (psi) | Day 14 (psi) | Day 28 (psi) |
|---|---|---|---|---|
| A. | Plain w/ 2% air | 5639.4 | 6482.9 | 7284.0 |
| B. | 5% Polypropylene | 4591.6 | 5085.0 | 5878.1 |
| | w/ 2% air | | | |
| C. | 15% Polypropylene | 3512.0 | 4437.8 | 4997.5 |
| | w/2% air | | | |

### Example 2

Three formulations of cement concrete with 6% air content were prepared in a laboratory setting according to the method illustrated in FIG. 3 and using the mixture proportions shown in Table 4. The water-cement ratio for all formulations was 0.40. The expanded plastic polymer aggregate used consisted of one part 1″ diameter expanded polypropylene pellets and two parts ¼″ diameter polypropylene pellets. The coarse and intermediate aggregate consisted of limestone aggregate not exceeding 1″. The fine aggregate consisted of river sand. Type 1 Portland cement was used for all formulations.

TABLE 4
Mixture Proportions (6% Air)

| | | | | | | | | Air |
|---|---|---|---|---|---|---|---|---|
| | | | | | | Expanded | Super- | Entraining |
| | | | | | | Plastic | plasticizer | Agent |
| | Water | Cement | Fine | Coarse | Inter. | Polymer | (% mass of | (% mass of |
| Formulation | (lb) | (lb) | Agg. (lb) | Agg. (lb) | Agg. (lb) | Agg. (lb) | cement) | cement) |
| A. Plain w/ 6% air | 188 | 470 | 1184.5 | 1162.1 | 888.4 | 0 | 0.5 | 0.04 |
| B. 5% Polypropylene | 188 | 470 | 1184.5 | 1133.0 | 866.2 | 51.3 | 0.5 | 0.04 |
| w/ 6% air | | | | | | | | |
| C. 15% Polypropylene | 188 | 470 | 1184.5 | 1074.9 | 821.2 | 153.8 | 0.5 | 0.04 |
| w/ 6% air | | | | | | | | |

The freeze-thaw resistance of each formulation of cement concrete identified in Table 4 was determined by calculating the durability factor for each formulation. Three samples of each formulation were subjected to 300 freeze-thaw cycles in the laboratory, the relative dynamic modulus of elasticity for each sample was determined, and the durability factor for each sample was calculated. The durability factor for each sample of each formulation after the full 300 freeze-thaw cycles is shown in Table 5.

TABLE 5
Durability Factor (DF) (6% Air)

| | | Sample 1 | Sample 2 | Sample 3 | Average |
|---|---|---|---|---|---|
| Formulation | | DF | DF | DF | DF |
| A. | Plain w/ 6% air | 78.80373 | 80.63755 | 78.65811 | 79.37 |
| B. | 5% Polypropylene | 75.56495 | 82.12891 | 77.11035 | 78.27 |
| | w/ 6% air | | | | |
| C. | 15% Polypropylene | 75.98792 | 81.58169 | 77.11035 | 78.23 |
| | w/ 6% air | | | | |

The strength of each formulation of cement concrete identified in Table 4 was determined by calculating the compressive strength of three samples of each formulation as tested after 7, 14, and 28 days. The average compressive strength of each formulation after 7, 14, and 28 days is shown in Table 6

TABLE 6
Average Compressive Strength (6% Air)

| Formulation | | Day 7 (psi) | Day 14 (psi) | Day 28 (psi) |
|---|---|---|---|---|
| A. | Plain w/ 6% air | 4283.9 | 4891.4 | 5819.8 |
| B. | 5% Polypropylene | 3451.0 | 4474.9 | 5321.1 |
| | w/ 6% air | | | |
| C. | 15% Polypropylene | 2204.3 | 3302.5 | 4217.6 |
| | w/ 6% air | | | |

The foregoing description of the preferred embodiments of the present invention has been presented for purposes of illustration. It is not intended to be exhaustive or to limit the invention to the precise forms disclosed. Many variations and modifications of the embodiments described herein will be apparent to one of ordinary skill in the art in light of the above description. The scope of the invention is to be defined only by the claims appended hereto.

I claim:

1. An insulative composite building material having improved thermal characteristics, comprising aggregate, said aggregate comprised of a portion of coarse mineral aggregate and a portion of expanded plastic polymer particles.

2. The composite building material of claim 1, wherein said portion of expanded plastic polymer particles comprises approximately 2% to 30% of the volume of said aggregate.

3. The composite building material of claim 1, wherein said portion of expanded plastic polymer particles comprises expanded polypropylene particles.

4. The composite building material of claim 1, wherein said expanded plastic polymer particles are substantially spherical and have diameters ranging from approximately ¼ inch to approximately 1 inch.

5. The composite building material of claim 1, wherein said composite building material is cement concrete.

6. An insulative composite building material having improved thermal characteristics, comprising:
(a) a binder; and
(b) aggregate, a portion of said aggregate comprising expanded plastic polymer aggregate.

7. The composite building material of claim 6, wherein said expanded plastic polymer aggregate comprises approximately 2% to 30% of the total volume of said aggregate.

8. The composite building material of claim 6, wherein said expanded plastic polymer aggregate comprises expanded polypropylene particles.

9. The composite building material of claim 6, wherein said expanded plastic polymer aggregate is substantially spherical and has a plurality of diameters ranging from approximately ¼ inch to approximately 1 inch.

10. The composite building material of claim 6, wherein said binder is cement.

11. A method of improving the insulative capacity of an aggregate composite building material, comprising incorporating a volume of expanded plastic polymer particles into an unset composite building material in place of a substantially equal volume of mineral aggregate.

12. The method of claim 11, wherein said expanded plastic polymer particles comprise approximately 2% to 30% of the combined volume of expanded plastic polymer particles and mineral aggregate.

13. The method of claim 11, wherein said expanded plastic polymer particles comprise expanded polypropylene particles.

14. The method of claim 11, wherein said expanded plastic polymer particles are substantially spherical and have diameters ranging from approximately ¼ inch to approximately 1 inch.

15. The method of claim 11, wherein said composite building material is cement concrete.

16. A method of improving the insulative capacity of cement concrete, comprising:
(a) mixing water, cement, coarse mineral aggregate, and expanded plastic polymer particles until a substantially homogeneous cement concrete mixture is obtained; and
(b) forming said mixture into a structural building component.

17. The method of claim 16, wherein said expanded plastic polymer particles comprise approximately 2% to 30% of the combined volume of expanded plastic polymer particles and coarse mineral aggregate.

18. The method of claim 16, wherein said expanded plastic polymer particles comprise expanded polypropylene particles.

19. The method of claim 16, wherein said expanded plastic polymer particles are substantially spherical and have diameters ranging from approximately ¼ inch to approximately 1 inch.

20. An insulative composite building material having improved thermal characteristics, comprising:
(a) cement;
(b) a portion of coarse mineral aggregate; and
(c) a portion of substantially spherical expanded polypropylene particles, wherein the volume of said portion of expanded polypropylene particles comprises approximately 2% to 30% of the combined volume of said portion of coarse mineral aggregate and said portion of expanded polypropylene particles.

21. The composite building material of claim 20, wherein said spherical expanded polypropylene particles have diameters ranging from approximately ¼ inch to 1 inch.
